(19) United States
(12) Patent Application Publication
(10) Pub. No.: US 2009/0043592 A1
(43) Pub. Date: Feb. 12, 2009

(54) METHOD AND SYSTEM FOR MANAGING PRODUCT DEVELOPMENT PROCESSES

(75) Inventors: Archim Heimann, Muehihausen (DE); Klaus Herter, Leimen (DE); Arno Mielke, Karlsruhe (DE)

Correspondence Address: FISH & RICHARDSON, P.C., PO BOX 1022, MINNEAPOLIS, MN, 55440-1022, US

(73) Assignee: SAP AG, Walldorf (DE)

(21) Appl. No.: 11/834,534

(22) Filed: Aug. 6, 2007

(51) Int. Cl. G06Q 30/00

(52) U.S. Cl. 705/1

(57) ABSTRACT

Methods and systems for managing product development processes are provided. A computerized method for managing a process includes presenting to a user one or more templates based on a triggering event. Each template represents a process approach. The method also includes receiving from the user a selection of a particular template of the one or more templates. The method also includes creating a case from the particular template. The case includes multiple process topics associated with the particular template.

### TECHNICAL FIELD

This disclosure relates to computer systems and methods and, more particularly, to methods, systems, and software for managing product development processes.

### BACKGROUND

A typical product represents a product portfolio rather than a single product entity. Manufacturers tend to sell a solution package that consists of different aspects of a product residing in different domains. A car, for example, is a bundled solution of various warranties and services, which includes services related to financing and insurance, as well as a promise of mobility. A car dealer is essentially selling mobility and independence more so than a physical automobile. As a result, the variety of tasks and responsibilities considered from a product manager's perspective becomes increasingly complex. The product manager may have to deal with legal aspects, market conditions, customer requirements, upgrade requests, compatibility evaluations, and the list continues. Product managers may often use computer and data processing systems as tools.

In computer and data processing systems, user interaction is typically provided using a video display, a keyboard, and a mouse. The display is often presented through a graphical user interface (GUI). Such GUIs may provide the front-end for modules, applications, services, databases, or other local or remote processes. For example, the GUI may present data retrieved from a database in a user friendly form. In another example, the GUI may provide a front-end for an application with embedded customer relationship management (CRM), finance, and manufacturing capabilities. In such a case, this GUI may then provide a unified view of operations across CRM, manufacturing, and finance sub-systems or sub-modules. The user may through the GUI perform CRM, finance, manufacturing and other business processes with the application.

### SUMMARY

The disclosure provides various embodiments of systems, methods, and software for managing product development processes. In one embodiment, a method includes identifying a process life-cycle management business topic based on input from a user. The method also includes creating a mind grid based on the business topic. The mind grid includes multiple process topics. The process topics include a first process topic from a first group and a second process topic from a second group. The method also includes modifying the mind grid based on input from the user.

In another embodiment, software embodied in a computer-readable medium, that when executed by a processor causes the processor to present to a user one or more templates based on a triggering event. Each template represents a process approach. The software also causes the processor to receive from the user a selection of a particular template of the one or more templates. The software further causes the processor to create a case from the particular template. The case includes multiple process topics associated with the particular template.

In another embodiment, a system for managing a process includes memory storing one or more templates and one or more cases. The system also includes one or more processors communicatively coupled to the memory. The one or more processors are operable to present one or more templates based on a triggering event. Each template represents a process approach. The one or more processors are also operable to create a case from a selected one of the presented templates. The case includes multiple process topics associated with the selected one of the presented templates.

Each of the foregoing—as well as other disclosed—example methods may be computer implementable. Moreover some or all of these aspects may be further included in respective systems and software for managing product development processes. For example, software, computerized methods, and systems for managing product development processes may also include receiving from the user data associated with the triggering event, and assigning the data to a process topic.

The software, computerized methods, and systems may also include displaying the mind grid with a graphical representation or in a graphical user interface using a map layout or a matrix layout of the multiple process topics. They may further include receiving input from a user modifying the graphical representation or the graphical user interface. They may also include modifying the mind grid or underlying case based on modifications of the graphical representation or graphical user interface. The business topic may include a topic selected from the group consisting of: an engineering change; idea to concept; concept to product; hand-over to production; financial forecast; manufacturing conflict handling; cost estimation; sales activity coordination; service conception; complex go-life activities; strategic sourcing; and campaign planning.

The first and the second group and multiple process topics may include a first and a second entity, a first and a second department, a first and a second domain, a first and second layer of a system, or a first and a second location. The plurality of process topics may be associated with the business topic. Modifying the mind grid may include creating a dependency between the first and the second of the plurality based on input from the user. Modifying the mind grid may also include removing the first of the plurality based on input from the user or adding a third process topic to the mind grid based on input from the user. The triggering event may be an engineering change, a new concept, or an evaluation.

The modification to the graphical representation or graphical user interface may be an addition of a process topic, a relating of a first process topic with a second process topic, or a removal of a process topic. The graphical representation or graphical user interface may include an accordion. The accordion may include one or more pre-defined building blocks that may be decoupled from but correspond to process topics. The process topics are related to multiple business entities, organizational units, or layers of a system. In some cases, the user may bind the topics to the particular block. The graphical representation or graphical user interface may also include a container. The container may include at least one graphical representation of a process topic. The one or more pre-defined building blocks may be determined based on a user, a team, or a process. A selected pre-defined building block may be dragged and dropped from the accordion to the container to create a graphical representation of the process topic and a corresponding process topic in the mind grid or underlying case. The container may be operable to display a graphical representation of a process topic that corresponds to a process topic in the mind grid or underlying case. The graphical representation of the process topic may include a graphical representation of a status of the process topic in the mind grid or underlying case. The container may also be operable to display multiple graphical representations that correspond to process topics in the mind grid. The container may also include multiple graphical representations of process topics that are arranged in a map format or a matrix format.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 illustrates an example system for managing product development processes in accordance with one embodiment of the present disclosure;

FIG. 2A is a flowchart illustrating case population in accordance with one embodiment of the present disclosure;

FIG. 2B is a flowchart illustrating manipulation of process topics using a graphical user interface (GUI) in accordance with one embodiment of the present disclosure;

FIGS. 3A-C illustrate example GUIs for managing product development processes using a map layout similar to a mind map in accordance with one embodiment of the present invention; and

FIGS. 4A-C illustrate example GUIs for managing product development processes using a matrix layout similar to a stage-gate in accordance with one embodiment of the present invention.

### DETAILED DESCRIPTION

A core task of product life-cycle management (PLM) is to identify, trigger, and track PLM topics (also referred to herein as process topics) across entities, departments, domains, and locations. Today, product life cycle processes may lack transparency and flexibility, and in the future may become even more complex as additional aspects come into play (smart items, embedded systems, preemptive maintenance). The present subject matter defines an instrument of process definition, adaptation, tracking, simplified content formats, simplified exchange formats and simplified visualization for dedicated processes, such as an engineering change.

A project plays a dual role in resolving an underlying case, first as a planning instrument (the project structure), and second as the real process approach, that is, its results, involved parties, and documentation (the project content). Some aspects can be planned and controlled best by means of the process flow, and aspects can be structured and documented by the content. A project is the umbrella under which the different process topics, meta data and results are developed, but the project itself as an application or a business entity is not the environment to hold the project content. This content needs to be trackable and auditable, and therefore needs to last over a long period of time. Projects themselves may be inadequate repositories for the project content for a variety of reasons.

In many cases no project application is involved for reduced administration overhead. Furthermore, very often a context evaluation is needed to decide the right type and structure of a project. Hence, the project entity and application may come into play in a later step after the details of the setup are available. Also, the granularity of the project and its flexibility do not always fit the process needs. Indeed, the process may need to be adapted based on the information gathered during process execution. For example, within an engineering change case a project may guide the overall structure and define the target key performance indicators (KPIs) of the objectives. The process, however, is the layer where the work is done, the information is gathered, and individual steps are agreed, such as a quality inspection, a clarification of legal liability, or a supplier collaboration. These different process steps are not represented in the project because the project defines the tasks as the objectives, not the steps and the details of how to achieve these objectives.

There are essentially two sets of questions corresponding to the dual roles (i.e., the project structure and the project content). Typical questions that may be addressed by the project structure role include:

(1) Who needs to be involved?

(2) What are the affected components and their related aspects, documentations, warranties?

(3) How can the content be captured in a secure, long lasting data structure format that is interchangeable?

(4) What does an approval look like, what are the interdependencies?

(5) What does the process documentation look like?

Questions answered by the content-oriented role include:

(1) How are processes executed in terms of defining the steps?

(2) How do the steps need to be combined and what are the results of the steps?

(3) How are the steps recorded and what are the long-term, stabile, and secure data formats?

The present subject matter builds upon the dual role of projects. There are generally two layers of the present subject matter. The first, herein termed the process approach case, is a flexible but template-based structure that represents the main structure and approach of a process. It is based on documents including office tools and free text annotations, references to Business Objects, URLs and web content, catalog systems, etc. This hierarchy of information and documentation may be enriched with status, responsibility and context specific meta data. In contrast to the project structure, the process approach case may be the complete recording of every piece of information of importance for a given process. It is important that this structure also includes non mature information at a given stage of the process. Such a case may occur with the semantic of a concept case, an evaluation case, or an engineering change case, to name a few examples.

The second layer, a mind grid, delivers the graphical representation of the process that is an abstraction of the corresponding structure of a backend case. In one embodiment, this mind grid may be a service that is offered to heterogeneous systems. Regardless, the mind grid is rather designed from a logical point of view than from a physical persistence view of process information. The basic idea of such a mind grid is to represent a process the way it is thought of rather than the way it is executed in detail. The look and feel of one embodiment of the mind grid, the map layout, casts the style into a process oriented semantic. The look and feel of another embodiment of the mind grid, may be a matrix layout. At a high level, mind grids are the representation of process topics, relationships of process topics and process knowledge in graphs. In other words, this mind grid can make well defined suggestions according existing knowledge.

The mind grid is similar to real world maps. That is, the mind grid represents the main aspects of a process like suburbs of a city and its associations. The map layout allows one to visualize the overall topology of a process. In addition each process topic may display metadata, such as status, responsibility and context specific KPIs. Mind grids may be pattern based and adaptable at runtime, such that a process topic may be added to or omitted from the mind grid instance. A development project and each process topic have inputs, criteria, and outputs. Milestones with pre- and post-conditions can be used to link the nodes. The dependencies in mind grids do not have to conform to a formalized structure or strong business semantic. The mind grid may be a valuable compromise between getting the process overview and the key master data of its process topics.

In a mind grid, especially the map layout, process topics do no necessarily follow a strong sequence of steps like a workflow model. In the map layout, a main idea is arranging process topics concentric around the issuing trigger of a process—its root. This allows concurrent work on different process topics in parallel and supports a more information driven approach than a strong scheduled matrix layout process. The matrix layout, which is also supported, may be appropriate when the mind grid begins to increase in complexity of the life cycle of the project. In certain cases, the matrix layout may facilitate interaction when the range of users is broadened from a few to several across a firm's organizational structure.

In contrast to business-object oriented user interfaces (UIs), the mind grid allows users to arrange process topics across business entities, layers of the system landscape and across organizational units. The underlying idea is to arrange and group process topics in the way they are thought of and not in the way the entities are designed. It is also important to mention that the mind map is not a traditional UI, but is a simplified process navigation and monitoring layer with interactive process modeling capabilities.

Mind grids allow flexible and iterative collection of key issues of a PLM, light weight composition (could be user or experience driven), and other business topics. Some PLM business topics include, but are not limited to, engineering change; idea to concept; concept to product; hand-over to production; financial forecast; manufacturing conflict handling; complex structuring questions for an organizational setup/recruiting; cost estimation; sales activity coordination; service conception; complex go-life activities; strategic sourcing; and campaign planning. Hence, mind grids may help users attain the full potential of a service oriented architecture and answer PLM questions on a broader enterprise and process level.

In short, mind grids focus on a semantic precise business goal and its process with a scope across business entities, organizational levels, systems and partners; provide an overview over complex process structures and its relationships and key data; allow to drill down for specific process steps, evaluations and decisions; and have a corresponding backend representation that severs as the source of information for reuse, audit and publication of data. The process approach layer serves as the single source of the process achievements even where the process is still running and information is not yet mature.

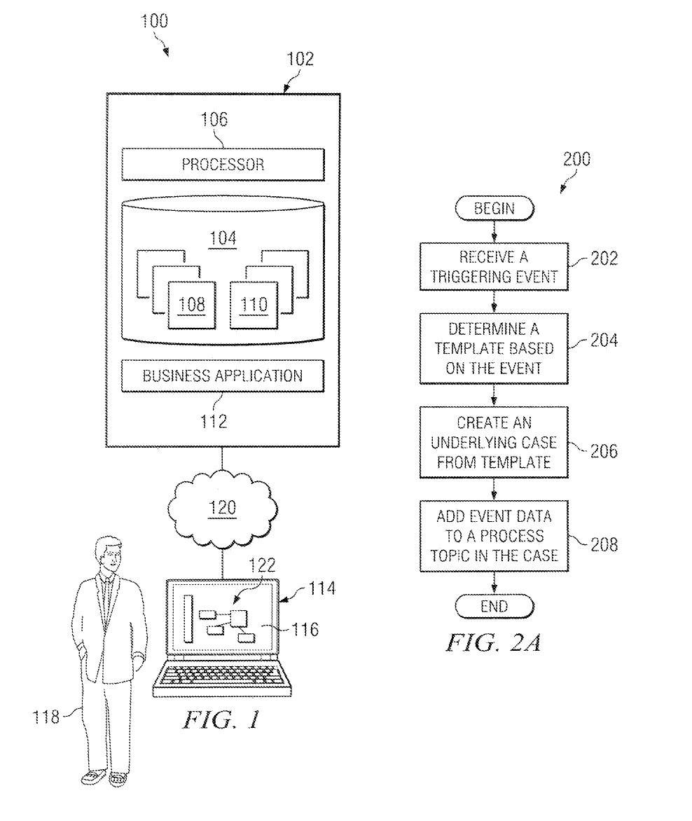

Turning now to FIG. 1, an example system 100 for managing product development processes is illustrated. Generally, system 100 allows a user 118 to create, manage, and interact through a graphical user interface (GUI) 116 implementing a mind grid with the process approach represented by an underlying case 110. The underlying case 110 may be created using a template 108 selected by a user 118. The GUI 116, among other things, may provide a user 118 with a mind grid to facilitate the managing of a case. The objects in the mind grid may correspond to business objects in the underlying case 110 or in system 100. The underlying case 110 is hosted on a remote server 102, which is running a business application 112. The GUI 116 is hosted on a client 114 that is communicatively coupled to the remote server 102. The data in the GUI 116 is linked to the data in the underlying case 110.

By representing the underlying case 110 using a mind grid, product managers may be enabled to work the way they think of a PLM problem, and to transform the PLM problem into an executable cluster of coherent work packages. It may also allow existing business entities, work centers, and business process models to reach their full potential of becoming a true PLM solution. With a service oriented view provided by the mind grid using GUI 116, there may be no need to know the structure of underlying business objects in order to understand the status of a project; the status may be determined by simple looking to the status indicator of each process topic, which may be implemented as a red, green, or yellow light. Use of a mind grid through GUI 116 may also free structuring to be independent of any platform or backend constraints; allow for fast response times and desktop like interaction; and allow configuration of the degree to which different users 118 have visibility to each part of the process. Further, some embodiments create an intuitive and easy navigation between overview and detail levels, therefore increasing the efficiency of certain users 118. Mind grids may also allow users to word the definition of business topics independent of their fulfillment. Finally, because a mind grid represents a complete (or near-complete) picture of the status (e.g., indicator as simple as a red, green, or yellow light) and contains the content of the process topics (the process approach layer), the amount of correspondence explaining the status between different stakeholders in the process can be greatly reduced since each stakeholder need only reference the mind grid and drill down to get the latest information concerning the project.

System 100, as illustrated in FIG. 1, is typically a distributed client/server system that spans one or more networks such as 120. Rather than being delivered as packaged software, system 100 may represent a hosted solution, often for an enterprise or other small business, that may scale cost-effectively and help drive faster adoption. In this case, portions of the hosted solution may be developed by a first entity, while other components are developed by a second entity. These entities may participate in any suitable form of revenue or cost sharing as appropriate. Moreover, the processes or activities of the hosted solution may be distribution amongst these entities and their respective components. For example, system 100 may implement binding software that connects the GUI 116 with the data in the underlying case 110 or that connects the data in the underlying case 110 with business objects stored on another system, where the binding software is created by a third party. Furthermore, the GUI 116 may be created using any commercially available software as described below. Further, system 100 may store data (user, transaction, service provider, and such) at a relatively central location (over WAN), while concurrently maintaining local data at the client 114 for redundancy and to allow processing during downtime. But system 100 may be in a dedicated enterprise environment—across a local area network (over LAN) or subnet—or any other suitable environment without departing from the scope of this disclosure.

Turning to the illustrated embodiment, system 100 includes or is communicably coupled with server 102, a client 114, and a user 118, at least some of which communicate across network 120. Server 102 comprises an electronic computing device operable to receive, transmit, process and store data associated with system 100. Each computer is generally intended to encompass any suitable processing device. For example, although FIG. 1 illustrates one server 102 that may be used with the disclosure, system 100 can be implemented using computers other than servers, as well as a server pool. Indeed, server 102 may be any computer or processing device such as, for example, a blade server, general-purpose personal computer (PC), Macintosh, workstation, Unix-based computer, or any other suitable device. In other words, the present disclosure contemplates computers other than general purpose computers as well as computers without conventional operating systems. Server 102 may be adapted to execute any operating system including Linux, UNIX, Windows Server, or any other suitable operating system. According to one embodiment, server 102 may also include or be communicably coupled with a web server and/or a mail server.

As illustrated, server 102 includes a memory 104 and a processor 106. The memory 104 may also be remote and connected to server 102 through a network, such as network 120. The memory 104 is computer readable media suitable for storing computer program instructions and data. The memory 104 may be any form of non volatile memory, media and memory devices, including by way of example random access memory (RAM), read-only memory (ROM), or other memory devices, such as, e.g., EPROM, EEPROM, and flash memory devices; magnetic disks, e.g., internal hard disks or removable disks; magneto optical disks; and CD ROM and DVD-ROM disks. The memory may include templates 108 and underlying cases 110. Although shown separately, the memory 104 may also include business application software 112.

A template 108 is a data structure that is collection of process topics and their relationships to one another. Each template 108 is related to a PLM business topic, also referred to as a triggering event. This triggering event may A triggering event may have one or more templates 108 associated with it. A template 108 is used to create an underlying case 110. A template 108 may describe the default process topics to include in a newly created underlying case 110 instantiated from the template 108, as well as default dependencies between the default process topics. A user 118 is not required to use every default process topic, and may freely change the dependencies of the default process topic after the underlying case 110 has been created.

An underlying case 110 is a data structure that is created from a template 108. The template 108 relates to a type of triggering event, but the underlying case 110 relates to the actual triggering event. For example, an engineering change triggering event that is received would correspond to a template 108 that defines which process topics relate to all engineering change events such as identification, specification, and project assignment. No data related to the particular engineering change event would be stored. The underlying case 110, in contrast, may have the process topics defined by the template 108 as well as information related to the actual received engineering change event. Such information may include the part number that malfunctioned and other information that concerns the actual received engineering change event. Essentially, the underlying case 110 may correspond to a mind grid and the related documents contained in the process approach.

In some embodiments, some or all of the foregoing data structures may be stored in one or more tables in a relational database described in terms of SQL statements or scripts. In some alternative or complimentary situations, some or all of the foregoing data structures may be formatted, stored, or defined as various data structures in text files, eXtensible Markup Language (“XML”) documents, Virtual Storage Access Method (“VSAM”) files, flat files, Btrieve files, comma-separated-value (“CSV”) files, internal variables, or one or more libraries. In short, the foregoing data structures may comprise one table or file or a plurality of tables or files stored on one computer or across a plurality of computers in any appropriate format. Indeed, some or all of the foregoing data structures may be local or remote without departing from the scope of this disclosure and store any type of appropriate data.

Server 102 also includes processor 106. Processor 106 executes instructions and manipulates data to perform the operations of server 102 such as, for example, a central processing unit (CPU), a blade, an application specific integrated circuit (ASIC), or a field-programmable gate array (FPGA). Generally, the processor 106 will be operatively coupled to receive data and/or instructions from, or transfer data to, the memory 104. The processor 106 and some or all of the data stored in the memory 104 can be supplemented by, or incorporated in, special purpose logic circuitry, such as an application-specific integrated circuit.

Server 102 may also include or reference a local, distributed, or hosted business application 112. At a high level, business application 112 is any application, program, module, process, or other software that may access, retrieve, modify, delete, or otherwise manage some information of the business object repository 140 in memory 120. Specifically, business application 112 may access the business object repository 140 to retrieve or modify data stored within specific business objects 145 as requested by a user and/or another application. Business application 112 may be considered business software or solution that is capable of interacting or integrating with business object repository 140 located, for example, in memory 120 to provide access to data for personal or business use. One example business application 112 may be a computer application for performing any suitable business process by implementing or executing a plurality of steps. Another example of a business application 112 is an application that provides interconnectivity with one or more business object repositories 140 containing product development information such that records may be dispersed among a plurality of business objects 145. As a result, business application 112 may provide a method of (or implement a process for) accessing requested data and presenting it to the user and/or application such that the user and/or application are provided information through a GUI interface 116 in a centralized manner. Business application 112 may also provide the user with a computer implementable method of implementing a centralized source for agreements on one or more solutions identified by a solution provider.

More specifically, business application 112 may be a composite application, or an application built on other applications, that includes an object access layer (OAL) and a service layer. In this example, application 112 may execute or provide a number of application services, such as CRM systems, human resources management (HRM) systems, financial management (FM) systems, project management (PM) systems, knowledge management (KM) systems, and electronic file and mail systems. Such an object access layer is operable to exchange data with a plurality of enterprise base systems and to present the data to a composite application through a uniform interface. The example service layer is operable to provide services to the composite application. These layers may help composite application 112 to orchestrate a business process in synchronization with other existing processes (e.g., native processes of enterprise base systems) and leverage existing investments in the IT platform. Further, composite application 112 may run on a heterogeneous IT platform. In doing so, composite application 112 may be cross-functional in that it may drive business processes across different applications, technologies, and organizations. Accordingly, composite application 112 may drive end-to-end business processes across heterogeneous systems or sub-systems. Application 112 may also include or be coupled with a persistence layer and one or more application system connectors. Such application system connectors enable data exchange and integration with enterprise sub-systems and may include an Enterprise Connector (EC) interface, an Internet Communication Manager/Internet Communication Framework (ICM/ICF) interface, an Encapsulated PostScript (EPS) interface, and/or other interfaces that provide Remote Function Call (RFC) capability. It will be understood that while this example describes the composite application 112, it may instead be a standalone or (relatively) simple software program. Regardless, application 112 may also perform processing automatically, which may indicate that the appropriate processing is substantially performed by at least one component of system 100. It should be understood that this disclosure further contemplates any suitable administrator or other user interaction with application 112 or other components of system 100 without departing from its original scope. Finally, it will be understood that system 100 may utilize or be coupled with various instances of business applications 130. For example, client 114 may run a first business application 112 that is communicably coupled with a second business application 112. Each business application 112 may represent different solutions, versions, or modules available from one or a plurality of software providers or developed in-house.

For example, portions of the composite application may be implemented as Enterprise Java Beans (EJBs) or design-time components may have the ability to generate run-time implementations into different platforms, such as J2EE (Java 2 Platform, Enterprise Edition), ABAP (Advanced Business Application Programming) objects, or Microsoft's .NET. Further, while illustrated as internal to server 102, one or more processes associated with application 112 may be stored, referenced, or executed remotely. For example, a portion of application 112 may be a web service that is remotely called, while another portion of application 112 may be an interface object bundled for processing at remote client 114. Moreover, application 112 may be a child or sub-module of another software module or enterprise application (not illustrated) without departing from the scope of this disclosure. Indeed, application 112 may be a hosted solution that allows multiple parties in different portions of the process to perform the respective processing. For example, client 114 may access application 112, once developed, on server 102 or even as a hosted application located over network 112 without departing from the scope of this disclosure. In another example, portions of software application 112 may be developed by the developer working directly at server 102, as well as remotely at client 114. Regardless of the particular implementation, “software” may include software, firmware, wired or programmed hardware, or any combination thereof as appropriate. Indeed, each of the foregoing software applications may be written or described in any appropriate computer language including C, C++, Java, Visual Basic, assembler, Perl, any suitable version of 4GL, as well as others. It will be understood that while these applications are shown as a single multi-tasked module that implements the various features and functionality through various objects, methods, or other processes, each may instead be a distributed application with multiple sub-modules. Further, while illustrated as internal to server 102, one or more processes associated with these applications may be stored, referenced, or executed remotely. Moreover, each of these software applications may be a child or sub-module of another software module or enterprise application (not illustrated) without departing from the scope of this disclosure.

Client 114 is any local or remote computing device operable to receive requests from the user via a user interface 116, such as a GUI, a CLI (Command Line Interface), or any of numerous other user interfaces. Thus, where reference is made to a particular interface, it should be understood that any other user interface may be substituted in its place. In various embodiments, each client 114 includes at least user interface 116 and comprises an electronic computing device operable to receive, transmit, process and store any appropriate data associated with environment 100. It will be understood that there may be any number of clients 114 communicably coupled to server 102. Further, “client” and “user” may be used interchangeably as appropriate without departing from the scope of this disclosure. Moreover, for ease of illustration, each client 114 is described in terms of being used by one user. But this disclosure contemplates that many users may use one computer or that one user may use multiple computers to submit or review queries via user interface 116. As used in this disclosure, client 114 is intended to encompass a personal computer, touch screen terminal, workstation, network computer, kiosk, wireless data port, wireless or wireline phone, personal data assistant (PDA), one or more processors within these or other devices, or any other suitable processing device. For example, client 114 may comprise a computer that includes an input device, such as a keypad, touch screen, mouse, or other device that can accept information, and an output device that conveys information associated with the operation of server 102 or clients 114, including digital data, visual information, or user interface 116. Both the input device and output device may include fixed or removable storage media such as a magnetic computer disk, CD-ROM, or other suitable media to both receive input from and provide output to users of client 114 through the display, namely user interface 116.

A GUI 116 is a computer program hosted on the client 114. GUI 116 comprises a graphical user interface operable to allow the user of client 114 to interface with at least a portion of system 100 for any suitable purpose, such as viewing application or other transaction data. Generally, GUI 116 provides the particular user with an efficient and user-friendly presentation of data provided by or communicated within system 100, such as the process topics of an underlying case 110 and their interdependencies. The GUI has presentation elements 122 which may correspond to data in the underlying case 110, and/or may correspond to other business objects of system 100. As shown in later figures, GUI 116 may comprise a plurality of customizable frames or views having interactive fields, pull-down lists, and buttons operated by the user 118. For example, GUI 116 may be operable to display certain presentation elements 122 in a user-friendly form based on the user context and the displayed data. GUI 116 may display a status of and/or an entity responsible for a process topic. GUI 116 is often configurable, supporting a combination of presentation elements 122, which may be relocated, resized, interrelated, and displayed in either a map layout or a matrix layout. It should be understood that the term graphical user interface may be used in the singular or in the plural to describe one or more graphical user interfaces and each of the displays of a particular graphical user interface. Indeed, reference to GUI 116 may indicate a reference to the front-end or a component of an application, as well as the particular interface accessible via client 114, as appropriate, without departing from the scope of this disclosure. Therefore, GUI 116 contemplates any graphical user interface, such as a generic web browser or touchscreen, that processes information in system 100 and efficiently presents the results to the user. Server 102 can accept data from client 114 via the web browser (e.g., Microsoft Internet Explorer or Netscape Navigator) and return the appropriate HTML or XML responses to the browser using network 120.

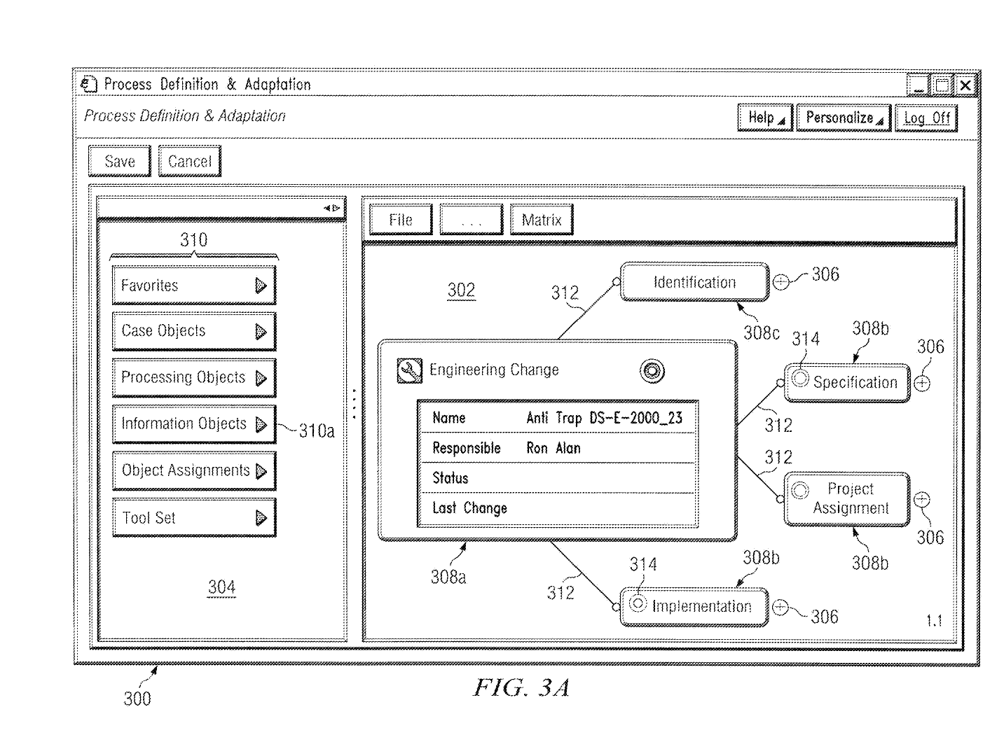

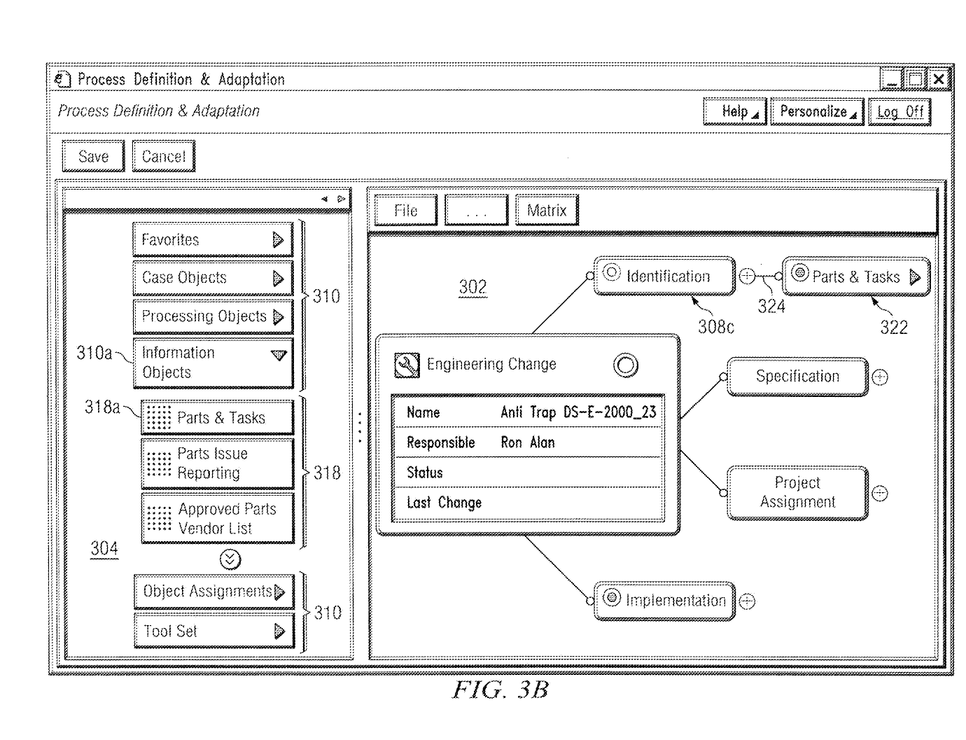

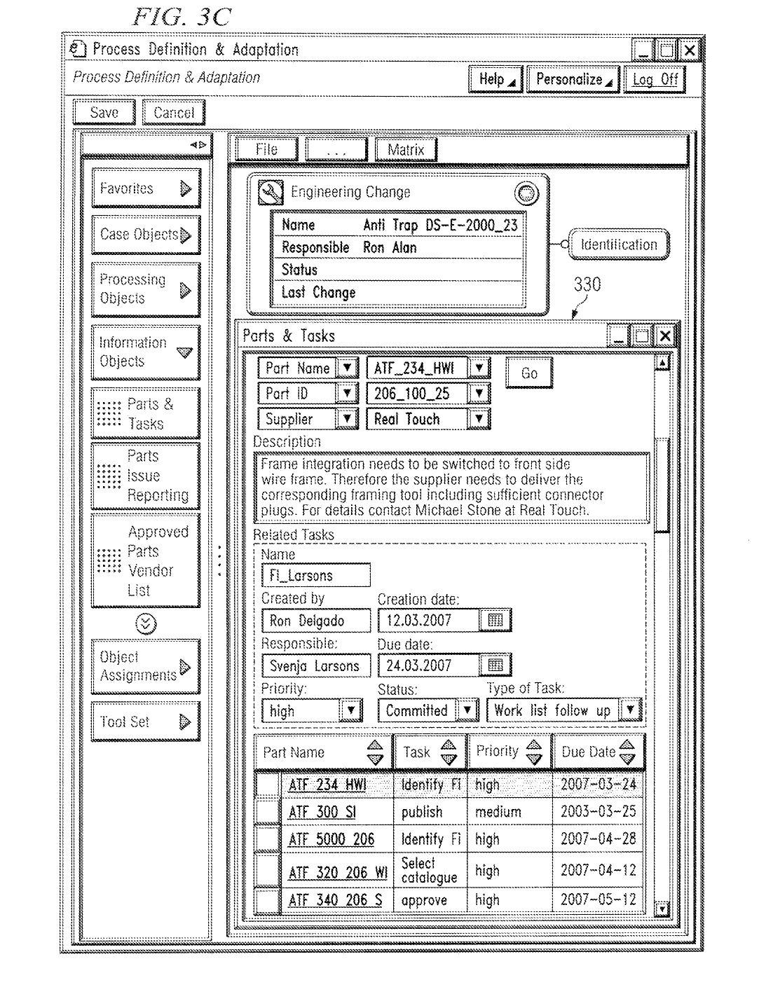

FIGS. 3A-C illustrate example GUIs for managing product development processes using a map layout similar to a mind map in accordance with one embodiment of the present invention. The mind map is an image-centered diagram that represents semantic or other connections between portions of information. By presenting these connections in a radial, non-linear graphical manner, it encourages a brainstorming approach to any given organizational task, eliminating the hurdle of initially establishing an intrinsically appropriate or relevant conceptual framework within which to work. Given its flexible and intuitive nature, the mind map is good for small groups and use earlier in a project before all the process topics and schedules are solidified. The map allows a user 118 to display the data in the way the user 118 thinks of the data as opposed to a formalized, inflexible structure.

Looking first to FIG. 3A, the map GUI 300 includes an editor 302, an accordion 304, a root process topic 308a, and a number of branch process topics 308b and 308c. Generally, new process topics 308b are added to the editor 302 using the accordion 304. The process topics 308b are related to one another and/or the root process topic 308a using dependencies 312.

At a high level, the editor 302 is a frame or window that acts as a display for the process topics 308 and their dependencies 312 and that allows the user to manipulate the underlying data and ontologies. The editor 302 displays the process topics that are currently a part of a given underlying case. There may be multiple editors 302 concurrently viewing and/or updating the same underlying case. Process topics 308 added to the editor 302 may be added to the underlying case, just as process topics 308 removed from the editor 302 may be removed from the underlying case. The synchronization of the GUI 300 with the underlying case may or may not be real-time or substantially real-time. The dependencies 312, which may be stored in any persistence layer, are represented in the editor 302 and may be rearranged, added, or removed.

The accordion 304 is a frame or window that houses groups of presentation elements representing different types of process topics. A variety of menus 310 may group together any combination of process topic templates 318 (shown in FIG. 3B). A process topic template 318 may be instantiated and added to the editor 302. In the example GUI 300, the menus include: “Favorites,” which may include process topics that follow the user across underlying cases; “Case Objects,” which may include concrete objects, such as a document, a bill of materials, and quality inspections; “Processing Objects,” which may be processing vehicles such as those that start an approval or a review process, start a black box collaboration, and are otherwise a clear processing vehicles where different business objects come together; and “Information Objects,” which may be analytics, such as how many defects from one supplier last year for a given product category that we bought in a certain window and whether a vendor has good quality at a good price. These groupings are merely examples and are not meant to be exhaustive of the different menus that may be in the accordion 304. In fact no menus are necessary, as the process topic templates 318 may be listed without any groupings. Likewise, the process topic templates 318 shown in FIG. 3B are merely examples and may include many other types of process topics, such as those discussed in reference to FIG. 1.

The process topics 308 are UI widgets that correspond to process topics in the underlying case. Each process topic 308 may include an identifier, such as “Engineering Change,” (at 308a), and a status 314. The process topics 308 exhibit certain context-specific behavior when clicked by a user. For example, clicking the root process topic 308a may cause the GUI 300 to spawn another window that shows the details of the Engineering Change, such as the requesting party, the date it was requested, the number of days elapsed since the change was initiated, and a host of other information that may be important to a user. The status 314 is an indicator of how the process topic is progressing. It can be implemented as a circle that changes color corresponding with changes in the progress. For example, a process topic that is stalled may have a status 314 that is red or yellow. There are many ways that a status 314 may be implemented. One purpose of the status 314 may be to allow a user to gauge the status of various process topics by simply glancing at the mind grid GUI 300.

The dependencies 312 may be used to connect process topics 308 together. A simple expression to relate two process topics may be used to create any kind of dependency. These dependencies may also exhibit certain behavior when clicked. For example, clicking a dependency 312 may launch a window that can be used to configure the dependency 312. Such a window may have widgets to define inputs, outputs, and success criteria. Each process topic 308 may have an expansion object 306 that may be used to hide or show process topics that fall under that particular process topic 308. By hiding the lower process topics 308, a user can concentrate on the overall status of an underlying case.

Turning now to FIG. 3B, in operation, a user may select one of the menus 310 in the accordion 304, such as the Information Objects menu 310a. When selected, the Information Objects menu 310a may expand to reveal processing topics 318 related to analytics. One process topic 318 may be Parts & Tasks 318a. A user may drag Parts & Tasks 318a from the accordion 304 and drop it into the editor 302 (at 322). An instance of Parts & Tasks 322 is created from the process topic template 318a. Once created, the instance of Parts & Tasks 322 may have a dependency 324 added connecting it with the Identification process topic 308c. Also, the instance of Parts & Tasks 322 may be configured by clicking on it. Doing so, may bring up a Parts & Tasks configuration window 330, as shown in FIG. 3C. The part and supplier information may be fully described using the configuration window 330. Other process topics 308 may have similar configuration windows that are context specific.

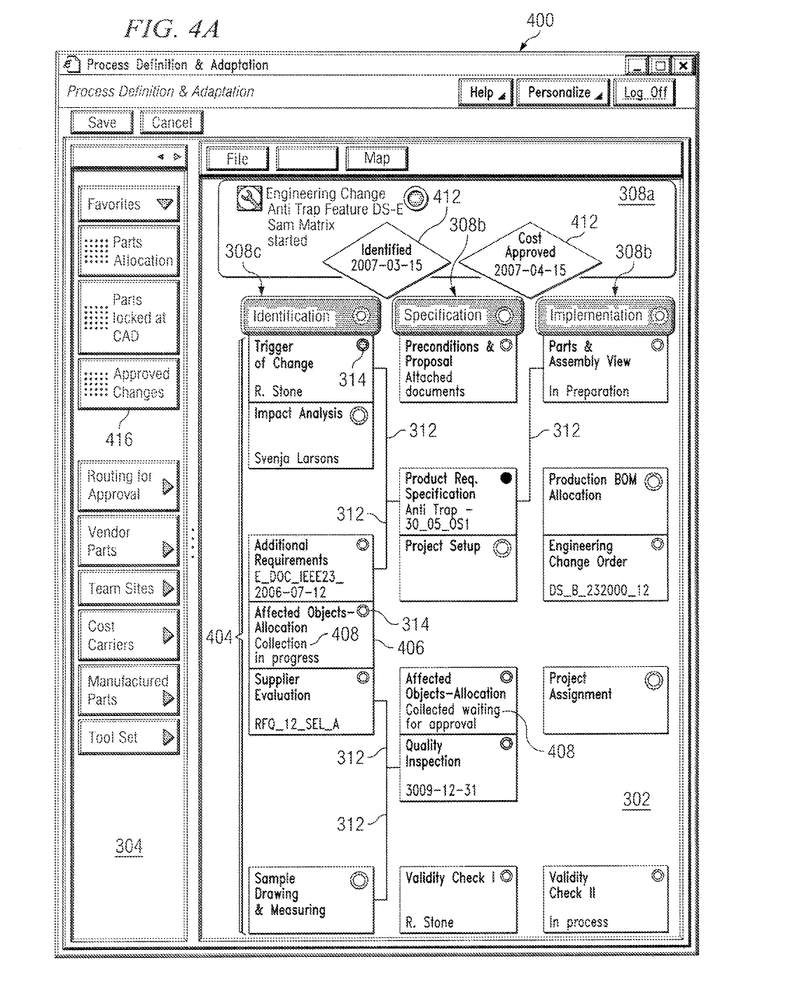

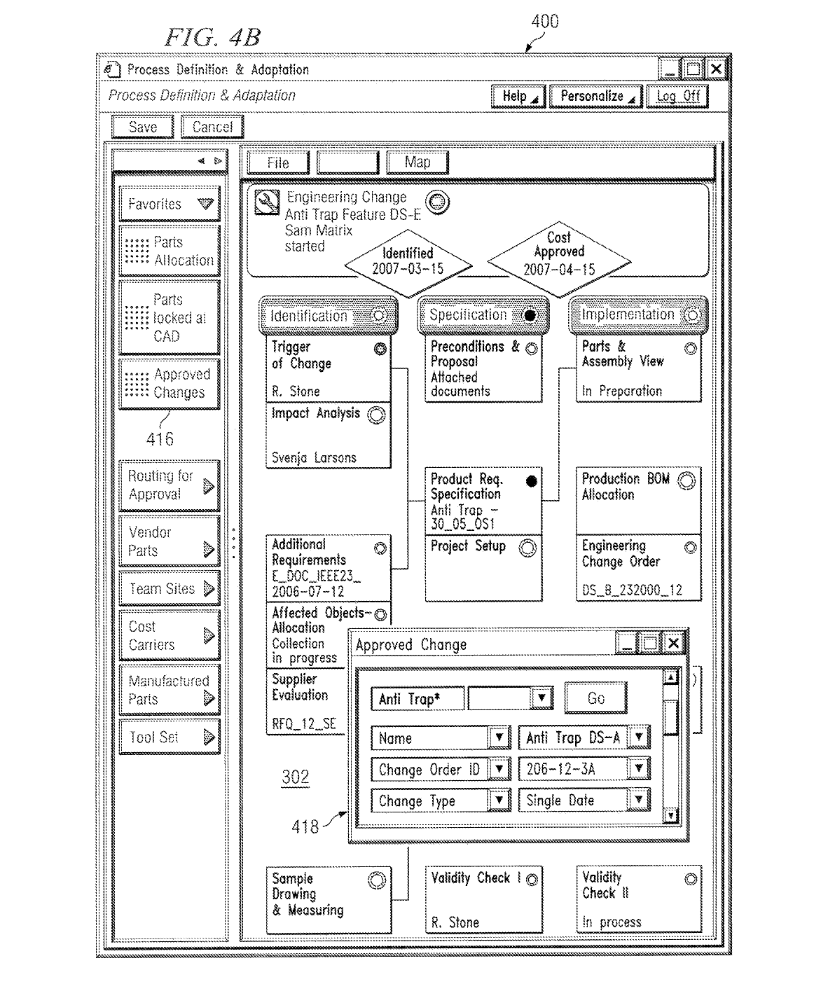

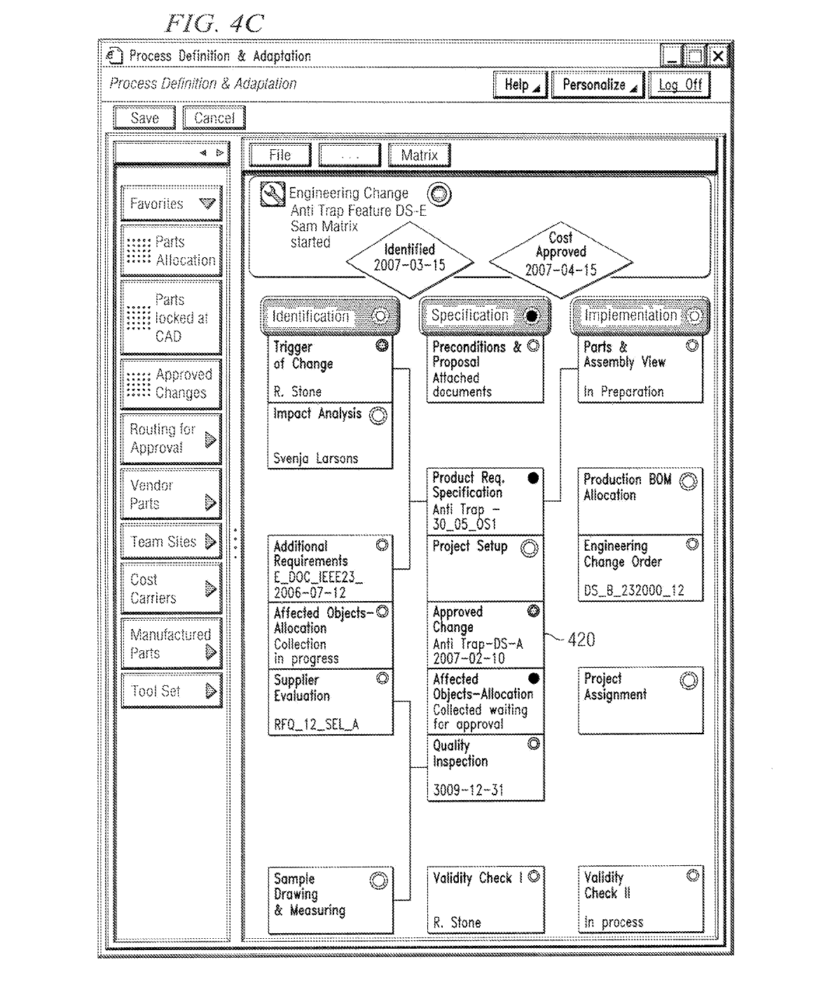

FIGS. 4A-C illustrate an example GUI 400 for managing product development processes using a matrix layout similar to a Stage-Gate (R) in accordance with one embodiment of the present invention. Similar to the map layout illustrated in FIGS. 3A-C, the matrix layout includes an editor 302 and an accordion 304. The presentation of the process topics 308 using the matrix layout is different from the presentation of the same elements in a map layout. For example, the root process topic 308a is shown to span across the editor 302 with each major process topics 308b and 308c having below it multiple lower process topics 404. Also introduced is process topic information 408, which may be used to expound on the status or display the responsible party for a given process topic 404. The process topics 404 are connected using dependencies 312. The major milestones 412 associated with the root process topic 308a may also be shown. Major milestones 412 may represent points in the process where a major portion or control of the process is transferred from one group to another or where major segments of the process are completed.

In operation, the matrix layout works similar to the map layout described in FIGS. 3A-C. In this illustration, a user may drag an Approved Changes process topic 416 from the accordion 304 into the editor 302. Once dropped into the editor 302, an instance of the Approved Changes process topic 416 may be created (at 420 of FIG. 4C) and configured (at 418 of FIG. 4B).

The GUIs may exhibit adaptive behavior. For example, the search context may be set based on selected business topic. Also, the GUIs may exhibit context sensitive behavior, for example, context menus or predefined selections. The GUIs may be programmed to make use of existing knowledge gathered from mind grids in the system to provide “what-if” analytics. The mind grid UI is not intended to act simply as an object maintenance UT like an Object Infrastructure Framework UI. The focus is on a holistic view on processing aspects and work streams within a given PLM context.

Network 120 facilitates wireless or wireline communication between computer server 102 and any other local or remote computer, such as client 114. Indeed, while illustrated as one network, network 120 may be a logically segregated or distributed network without departing from the scope of this disclosure, so long as at least portion of network 120 may facilitate communications between senders and recipients of requests and results. In other words, network 120 encompasses any internal and/or external network, networks, sub-network, or combination thereof operable to facilitate communications between various computing components in system 100. Network 120 may communicate, for example, Internet Protocol (IP) packets, Frame Relay frames, Asynchronous Transfer Mode (ATM) cells, voice, video, data, and other suitable information between network addresses. Network 120 may include one or more local area networks (LANs), radio access networks (RANs), metropolitan area networks (MANs), wide area networks (WANs), all or a portion of the global computer network known as the Internet, and/or any other communication system or systems at one or more locations.

In operation, a user 118 receives a triggering event and begins using system 100 to manage the process for handling the triggering event. The event may be a concrete product event, a quality or security issue, or a delivery of a contact. System 100 presents one or more templates 108 based on the triggering event, from which the user 118 selects one to create an underlying case 110. An underlying case 110 is instantiated using the selected template 108, and the process topics contained within the underlying case 110 are presented to the user 108 using the presentation elements 122 in GUI 116. The user 108 may then re-organize, add, and remove process objects in the underlying case using the GUI 116. Once the underlying case 110 is instantiated, the user 118 may bind to the root process topic the existing information in the event, such as correspondence from a customer, or a workflow item. The user 118 may then use the mind grid's underlying case 110 as if it were a staging area by clarifying and assigning tasks and identifying stakeholders. Once a triggering event is resolved, the user 118 may delete or keep data for auditing and tracking purposes.

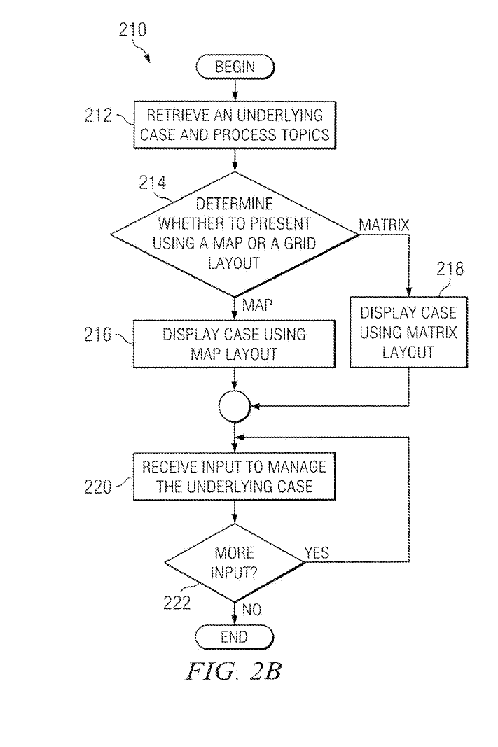

FIG. 2A is a flowchart illustrating an example method 200 for one aspect of managing a process using system 100. Generally, method 200 describes the creation of an underlying case in response to a triggering event. The user 118 receives a triggering event at step 202. This triggering event may have been received from a variety of sources, such as an electronic mail (e-mail) message or a phone call from a customer, a change request from staff conducting tests on a system, a memorandum from marketing describing new products that need to be developed, and so on. These triggering events, or root process topics, lead to the formation of an underlying case or mind grid. The resolution of the underlying case drives the process and provides context for the process topics associated with the underlying case.

At step 204, a template is determined based on the triggering event. Templates 108, briefly described above, are collections of predetermined process topics related to types of root process topics. A triggering event may have more than one template associated with it. For example, an engineering change case may have two types of templates associated with it depending on whether the change involves hardware or software. A user 118 may select a template based on a variety of factors, such as personal preference or adequateness of the template in capturing the process. If only one template 108 is available for the triggering event, then that template 108 is used.

At step 206, the system 100 creates an underlying case based on the template determined in step 204. The creation of an underlying case involves creating an instance of each process topic contained in the template. Each process topic may have associated with it business objects and related documentation. The underlying case may be a multi-dimensional data structure having links to other data structures and/or documents, such as spreadsheets, databases, word processing documents, web pages, or even web logs. In fact, any documents that pertain to resolving a root process topic may be contained or referenced in underlying case.

At step 208, the user 118 may add data associated with the triggering event to one or more process topics in the underlying case. For example, a change request may require that a system's software be updated by a certain date in order to meet a production deadline. This and other information initially known to the user 118 may be included in the underlying case.

FIG. 2B is also a flowchart illustrating an example method 210 for managing a process using system 100. Generally, after an underlying case has been created, method 210 describes how the underlying case may be retrieved, displayed, and edited using the GUI 116. As described above and in more detail in FIGS. 3A, 3B, 4A, and 4B, the presentation elements 122 in the GUI 116 may be arranged in essentially two types of layouts: a map layout, and a matrix layout. Turning back to FIG. 2B, a method 210 begins at step 212 where an underlying case containing process topics is retrieved. In addition to the process topics themselves, information describing the dependencies of the process topics with one another is also retrieved. Also, references to various documents related to the underlying case may be retrieved.

At step 214, system 100 determines whether to present the presentation elements 122 using a map layout or a grid layout. A user 118 may use a variety of factors to determine whether to use the map or the grid layout. One factor may be the overall maturity of the project. A project in its early stages may not have all of the process topics defined fully and may be viewed by only a few users. Having a few users increases the likelihood that the map layout will be easily understood. Also, the map layout provides ease of design and flexibility, which are appreciated early in the process. As the project matures, however, more people may become involved and the process may become increasingly complex. In this situation, a map layout may prove unwieldy and the structured view of the matrix layout may be more appropriate.

If it is determined that the map layout is the appropriate layout, then at step 216 the system 100 may display the underlying case using the map layout. If the matrix layout is determined to be the appropriate layout, then at step 218, the system 100 may display the underlying case using the matrix layout.

At step 220, the system 100 may receive input from the user 118 to manage the underlying case by adding, removing, or rearranging process topics or their related dependencies. At step 222, the system 100 waits for more input. If there is more input, then step 220 is executed again.

The preceding flowcharts and accompanying description illustrate example methods 200 and 210. It will be understood that this illustrated methods are for example purposes only and that the described or similar techniques or processes may be performed at any appropriate time, including concurrently, individually, or in combination. In addition, many of the steps in these flowcharts may take place simultaneously and/or in different orders than as shown. Moreover, methods may be used with additional steps, fewer steps, and/or different steps, so long as the methods remain appropriate.

This specification uses the terms “project” and “process,” which may include some or many overlapping aspects as appropriate. Accordingly, when either term is used in this specification it should be interpreted as meaning “project,” “process,” or both. The present subject matter may blur the distinction between a project and a process because both the project structure (sometimes referred to simply as the project) and the project approach (sometimes referred to as the process) may be readily managed in certain embodiments.

A number of embodiments of the invention have been described. Nevertheless, it will be understood that various modifications may be made without departing from the spirit and scope of the invention. For example, the underlying case and the mind grid may be one data structure or the creation of a mind grid from a triggering event may be automated. Accordingly, other embodiments are within the scope of the following claims.

What is claimed is:

1. A method comprising:
identifying a process life-cycle management business topic based on input from a user;
creating a mind grid based on the business topic, wherein the mind grid comprises a plurality of process topics, wherein a first of the plurality is from a first group and a second of the plurality is from a second group; and
modifying the mind grid based on input from the user.

2. The method of claim 1, wherein the business topic comprises a topic selected from the group consisting of: an engineering change; idea to concept; concept to product; hand-over to production; financial forecast; manufacturing conflict handling; cost estimation; sales activity coordination; service conception; complex go-life activities; strategic sourcing; and campaign planning.

3. The method of claim 1, wherein the first and the second group are selected from the set consisting of: a first and a second entity, a first and a second department, a first and a second domain, a first and second layer of a system, and a first and a second location.

4. The method of claim 1, wherein the plurality of process topics are associated with the business topic.

5. The method of claim 1, wherein modifying the mind grid comprises creating a dependency between the first and the second of the plurality based on input from the user.

6. The method of claim 1, wherein modifying the mind grid comprises removing the first of the plurality based on input from the user or adding a third process topic to the mind grid based on input from the user.

7. The method of claim 1, further comprising displaying the mind grid in a graphical user interface using a map layout or a matrix layout of the plurality of process topics.

8. Software comprising instructions embodied in a computer-readable medium, that are operable when executed by a processor to:
present to a user one or more templates based on a triggering event, wherein each template represents a process approach;
receive from the user a selection of a particular template of the one or more templates; and
create a case from the particular template, wherein the case comprises a plurality of process topics associated with the particular template.

9. The software of claim 8, wherein the triggering event comprises one of the set consisting of: an engineering change, a new concept, and an evaluation.

10. The software of claim 8, wherein the plurality of process topics comprises:
a first topic associated with a first business entity; and
a second topic associated with a second business entity.

11. The software of claim 8, wherein the plurality of process topics comprises:
a first topic associated with a first layer of a system; and
a second topic associated with a second layer of the system.

12. The software of claim 8, wherein the plurality of process topics comprises:
a first topic associated with a first organizational unit; and
a second topic associated with a second organizational unit.

13. The software of claim 8, further causing the processor to:
present to the user a graphical representation of the case;
receive a modification from the user to the graphical representation of the case; and
update the case to correspond to the modification to the graphical representation.

14. The software of claim 13, wherein the modification to the graphical representation is selected from the set consisting of: an addition of a process topic, a relating of a first process topic with a second process topic, and a removal of a process topic.

15. The software of claim 13, wherein the graphical representation comprises:
an accordion comprising one or more pre-defined building blocks that correspond to process topics, wherein the process topics are related to a plurality of business entities, a plurality of organizational units, or a plurality of layers of a system; and
a container comprising at least one graphical representation of a process topic.

16. The software of claim 15, wherein the one or more pre-defined building blocks is determined based on a user, a team, or a process.

17. The software of claim 15, wherein a selected one of the one or more pre-defined building blocks may be dragged and dropped from the accordion to the container to create a graphical representation of the process topic and a corresponding process topic in the mind grid.

18. The software of claim 15, wherein the container is operable to display a graphical representation of a process topic that corresponds to a process topic in the mind grid, wherein the graphical representation comprises a graphical representation of a status of the process topic in the mind grid.

19. The software of claim 15, wherein the container is operable to display a plurality of graphical representations that correspond to process topics in the mind grid.

20. The software of claim 15, wherein the container comprises a plurality of graphical representations of process topics that are arranged in a map format or a matrix format.

21. The software of claim 8, further comprising:
receiving from the user data associated with the event; and
assigning data associated with the event to a first of the plurality of process topics.

22. A system for managing a process, comprising:
memory storing one or more templates and one or more cases; and
one or more processors communicatively coupled to the memory, operable to:
present one or more templates based on a triggering event, wherein each template represents a process approach; and
create a case from a selected one of the presented templates, wherein the case comprises a plurality of process topics associated with the selected one of the presented templates.

23. The system of claim 22, wherein the processor is further operable to:
present a graphical representation of the case in a graphical user interface;
receive a change to the graphical user interface from a user; and
update the case to correspond to the change made in the graphical user interface.
